(19) United States
(12) Patent Application Publication
(10) Pub. No.: US 2025/0266441 A1
(43) Pub. Date: Aug. 21, 2025

(54) NON-AQUEOUS ELECTROLYTE SECONDARY BATTERY

(71) Applicant: Panasonic Energy Co., Ltd., Moriguchi-shi, Osaka (JP)

(72) Inventors: Yasunobu Kawamoto, Osaka (JP); Toshinobu Kanai, Hyogo (JP)

(73) Assignee: Panasonic Energy Co., Ltd., Moriguchi-shi, Osaka (JP)

(21) Appl. No.: 18/857,266

(22) PCT Filed: Apr. 24, 2023
(86) PCT No.: PCT/JP2023/016123

§ 371 Date: Oct. 16, 2024

(30) Foreign Application Priority Data
Apr. 25, 2022 (JP) 2022-071642

(51) Int. Cl. H01M 4/525; H01M 4/02; H01M 4/131; H01M 4/36

(52) U.S. Cl. CPC H01M 4/525; H01M 4/131; H01M 4/364; H01M 2004/021; H01M 2004/028

(57) ABSTRACT

A positive electrode mixture layer in this secondary battery contains a first positive electrode active material having a particle fracture strength of 90 MPa or less and a second positive electrode active material having a particle fracture strength of 110 MPa or greater. The first positive electrode active material is a lithium transition metal complex oxide that contains Ni and Mn, and has a Co content ratio of 1 mol % or less. The second positive electrode active material is a lithium transition metal complex oxide that contains Ni and Co, and has a Co content ratio of 3 mol % or greater. Regarding the positive electrode mixture layer, the content of the first positive active material is at least 5 mass % but less than 50 mass % with respect to the combined mass of the first positive electrode active material and the second positive electrode active material.

### TECHNICAL FIELD

The present disclosure relates to a non-aqueous electrolyte secondary battery.

### BACKGROUND ART

A lithium-transition metal composite oxide containing Ni and Co has been conventionally used as a positive electrode active material with high capacity. Since Co is expensive, there have been investigations on reduction in a content rate of Co in the positive electrode active material. For example, Patent Literature 1 discloses art in which a first positive electrode active material having a high content rate of Co adheres to a surface of a second positive electrode active material having a low content rate of Co to improve output characteristics while reducing the content rate of Co.

### CITATION LIST

### Patent Literature

PATENT LITERATURE 1: International Publication No. WO2013/038918

### SUMMARY

A design of increasing a content rate of Ni in the lithium-transition metal composite oxide as the positive electrode active material is considered from the viewpoint of increasing the capacity. However, when the content rate of Co is reduced and the content rate of Ni is set to greater than or equal to 85 mol % relative to the total number of moles of metal elements excluding Li, load characteristics may be deteriorated. Patent Literature 1 does not investigate achievement of both the reduction in Co and improvement of the load characteristics, and still has room for improvement.

It is an advantage of the present disclosure to provide a non-aqueous electrolyte secondary battery with a low cost and excellent load characteristics.

A non-aqueous electrolyte secondary battery of an aspect of the present disclosure comprises: a positive electrode; a negative electrode; a separator separating the positive electrode and the negative electrode from each other; and a non-aqueous electrolyte, wherein the positive electrode has a positive electrode current collector and a positive electrode mixture layer formed on a surface of the positive electrode current collector, the positive electrode mixture layer includes a first positive electrode active material having a particle fracture strength of less than or equal to 90 MPa and a second positive electrode active material having a particle fracture strength of greater than or equal to 110 MPa, the first positive electrode active material is a lithium-transition metal composite oxide containing Ni and Mn, and a content rate of Ni is greater than or equal to 85 mol % and less than or equal to 94 mol % and a content rate of Co is less than or equal to 1 mol % relative to a total number of moles of metal elements excluding Li, the second positive electrode active material is a lithium-transition metal composite oxide containing Ni and Co, and a content rate of Ni is greater than or equal to 85 mol % and less than or equal to 94 mol % and a content rate of Co is greater than or equal to 3 mol % relative to a total number of moles of metal elements excluding Li, and in the positive electrode mixture layer, a content of the first positive electrode active material is greater than or equal to 5 mass % and less than 50 mass % relative to a total mass of the first positive electrode active material and the second positive electrode active material.

According to the non-aqueous electrolyte secondary battery of the present disclosure, both the low cost and the improvement of the load characteristics can be achieved.

### BRIEF DESCRIPTION OF DRAWING

FIG. 1 is an axial sectional view of a cylindrical secondary battery of an example of an embodiment.

### DESCRIPTION OF EMBODIMENTS

Hereinafter, an example of an embodiment of a cylindrical secondary battery according to the present disclosure will be described in detail with reference to the drawing. In the following description, specific shapes, materials, values, directions, and the like, which are examples for facilitating understanding of the present invention, may be appropriately modified with specifications of secondary batteries. Hereinafter, a cylindrical secondary battery in which a wound electrode assembly is housed in a cylindrical exterior will be exemplified, but the electrode assembly is not limited to the wound electrode assembly, and may be a stacked electrode assembly in which a plurality of positive electrodes and a plurality of negative electrodes are alternately stacked one by one via a separator. The exterior is not limited to the cylindrical exterior, and may be, for example, a rectangular exterior or a coin-shaped exterior. The exterior may be a pouch composed of laminated sheets including a metal layer and a resin layer. The description “a numerical value (A) to a numerical value (B)” herein means greater than or equal to the value (A) and less than or equal to the value (B).

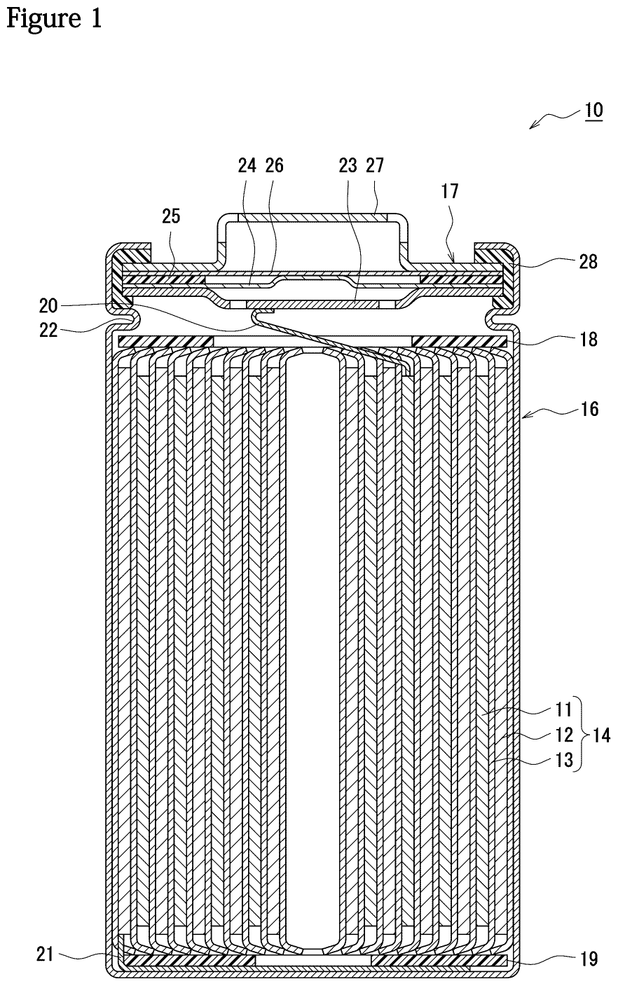

FIG. 1 is a sectional view of a cylindrical secondary battery 10 of an example of an embodiment. As illustrated in FIG. 1, the secondary battery 10 comprises a wound electrode assembly 14, a non-aqueous electrolyte, and an exterior housing can 16 housing the electrode assembly 14 and the non-aqueous electrolyte. The electrode assembly 14 has a positive electrode 11, a negative electrode 12, and a separator 13, and has a wound structure in which the positive electrode 11 and the negative electrode 12 are spirally wound via the separator 13. The exterior housing can 16 is a bottomed cylindrical metallic container having an opening on one side in an axial direction, and the opening of the exterior housing can 16 is capped with a sealing assembly 17. Hereinafter, for convenience of description, the sealing assembly 17 side of the battery will be described as the upper side, and the bottom side of the exterior housing can 16 will be described as the lower side.

All of the positive electrode 11, the negative electrode 12, and the separator 13 that constitute the electrode assembly 14 have an elongated band-shape, and are spirally wound to be alternately stacked in a radial direction of the electrode assembly 14. The separator 13 separates the positive electrode 11 and the negative electrode 12 each other. To prevent precipitation of lithium, the negative electrode 12 is formed to be one size larger than the positive electrode 11. That is, the negative electrode 12 is formed to be longer than the positive electrode 11 in a longitudinal direction and a width direction (short direction). Two of the separator 13 are formed to be one size larger than at least the positive electrode 11, and disposed to sandwich the positive electrode 11. The electrode assembly 14 comprises: a positive electrode lead 20 connected to the positive electrode 11 by welding or the like; and a negative electrode lead 21 connected to the negative electrode 12 by welding or the like.

Insulating plates 18 and 19 are disposed on the upper and lower sides of the electrode assembly 14, respectively. In the example illustrated in FIG. 1, the positive electrode lead 20 extends through a through hole in the insulating plate 18 toward a side of the sealing assembly 17, and the negative electrode lead 21 extends along an outside of the insulating plate 19 toward the bottom side of the exterior housing can 16. The positive electrode lead 20 is connected to a lower surface of an internal terminal plate 23 of the sealing assembly 17 by welding or the like, and a cap 27, which is a top plate of the sealing assembly 17 electrically connected to the internal terminal plate 23, becomes a positive electrode terminal. The negative electrode lead 21 is connected to a bottom inner surface of the exterior housing can 16 by welding or the like, and the exterior housing can 16 becomes a negative electrode terminal.

A gasket 28 is provided between the exterior housing can 16 and the sealing assembly 17 to achieve sealability inside the battery. On the exterior housing can 16, a grooved portion 22 in which a part of a side wall thereof projects inward for supporting the sealing assembly 17 is formed. The grooved portion 22 is preferably formed in a circular shape along a circumferential direction of the exterior housing can 16, and supports the sealing assembly 17 with the upper surface thereof. The sealing assembly 17 is fixed on the upper part of the exterior housing can 16 with the grooved portion 22 and with an end of the opening of the exterior housing can 16 caulked to the sealing assembly 17.

The sealing assembly 17 has a stacked structure of the internal terminal plate 23, a lower vent member 24, an insulating member 25, an upper vent member 26, and the cap 27 in this order from the electrode assembly 14 side. Each member constituting the sealing assembly 17 has, for example, a disk shape or a ring shape, and each member except for the insulating member 25 is electrically connected to each other. The lower vent member 24 and the upper vent member 26 are connected at respective central parts thereof, and the insulating member 25 is interposed between the respective circumferential parts thereof. If the internal pressure of the battery increases due to abnormal heat generation, the lower vent member 24 is deformed so as to push the upper vent member 26 up toward the cap 27 side and breaks, and thereby a current pathway between the lower vent member 24 and the upper vent member 26 is cut off. If the internal pressure further increases, the upper vent member 26 breaks, and gas is discharged through the opening of the cap 27.

Hereinafter, the positive electrode 11, the negative electrode 12, the separator 13, and the non-aqueous electrolyte, which constitute the secondary battery 10, particularly the positive electrode 11, will be described in detail.

### [Positive Electrode]

The positive electrode 11 has a positive electrode current collector and a positive electrode mixture layer formed on a surface of the positive electrode current collector. The positive electrode mixture layer is preferably formed on both surfaces of the positive electrode current collector. For the positive electrode current collector, a foil of a metal stable within a potential range of the positive electrode 11, such as aluminum and an aluminum alloy, a film in which such a metal is disposed on a surface layer, or the like can be used.

The positive electrode mixture layer includes, for example, a positive electrode active material, a binder and a conductive agent. A content of the positive electrode active material in the positive electrode mixture layer is, for example, greater than or equal to 80 mass % and less than or equal to 99 mass % relative to a total mass of the positive electrode mixture layer. The positive electrode 11 can be produced by, for example, applying a positive electrode mixture slurry including the positive electrode active material, the binder, the conductive agent and the like on the surface of the positive electrode current collector, drying the coating film, and then rolling the coating film by using a roller or the like.

Examples of the conductive agent included in the positive electrode mixture layer include carbon-based particles such as carbon black (CB), acetylene black (AB), Ketjenblack, carbon nanotube (CNT), graphene, and graphite. These may be used singly, or may be used in combination of two or more.

Examples of the binder included in the positive electrode mixture layer include a fluororesin such as polytetrafluoroethylene (PTFE) and polyvinylidene fluoride (PVDF), a polyimide resin, an acrylic resin, a polyolefin resin, and polyacrylonitrile (PAN). These may be used singly, or may be used in combination of two or more thereof.

The positive electrode active material included in the positive electrode mixture layer is a lithium-transition metal composite oxide, for example. The lithium-transition metal composite oxide may have, for example, a layered structure belonging to the space group R-3m, a layered structure belonging to the space group C2/m, and the like. Among them, the layered structure belonging to the space group R-3m is preferable in terms of the higher capacity, the stability of the crystal structure, and the like. The layered structure of the lithium-transition metal composite oxide may include a transition metal layer, a Li layer, and an oxygen layer.

The lithium-transition metal composite oxide includes secondary particles each formed by aggregation of primary particles, for example. A particle diameter of the primary particles constituting the secondary particles of the lithium-transition metal composite oxide is, for example, greater than or equal to 0.02 μm and less than or equal to 2 μm. The particle diameter of the primary particles is measured as a diameter of a circumscribed circle in a particle image observed with a scanning electron microscope (SEM). An average particle diameter of the secondary particles of the lithium-transition metal composite oxide is, for example, greater than or equal to 2 μm and less than or equal to 30 μm. The average particle diameter herein means a median diameter (D50) on a volumetric basis. The D50 means a particle diameter at which a cumulative frequency is 50% from a smaller particle diameter side in a particle size distribution on a volumetric basis. The particle size distribution of the secondary particles of the lithium-transition metal composite oxide can be measured by using a laser diffraction-type particle size distribution measuring device (for example, MT3000II, manufactured by MicrotracBEL Corp.) with water as a dispersion medium.

The positive electrode mixture layer includes a first positive electrode active material having a particle fracture strength of less than or equal to 90 MPa and a second positive electrode active material having a particle fracture strength of greater than or equal to 110 MPa. With this configuration, the first positive electrode active material having the low particle fracture strength is preferentially broken during rolling of the positive electrode mixture layer in the positive electrode production, and a filling density of the positive electrode active material in the positive electrode mixture layer can be increased, which can increase the battery capacity. A lower limit of the particle fracture strength of the first positive electrode active material is, for example, 60 MPa. An upper limit of the particle fracture strength of the second positive electrode active material is, for example, 170 MPa. The particle fracture strength of the first positive electrode active material and the second positive electrode active material can be measured as follows.

### <Method for Measuring Particle Fracture Strength>

The particle fracture strength is measured by using a micro compression tester (MCT-W201) manufactured by SHIMADZU CORPORATION. The measurement procedure is as follows.

(1) Powder of the lithium-transition metal composite oxide as the positive electrode active material is sprayed on a lower pressuring plate (SKS plane plate) of the measurement device.
(2) With an optical microscope, a particle with a size close to an average particle diameter is selected.
(3) By using a flat indenter made of diamond with 50 μm in diameter as an upper indenter, only the one particle is present between this upper pressuring indenter and the lower pressuring plate.
(4) The upper pressing indenter is slowly lowered, and from a time at which the indenter is contacted with the particle of the lithium-transition metal composite oxide (a time at which the lowering speed changes), a load is started to be applied at a constant acceleration.
(5) A relationship between the load and the deformation amount of the particle of the lithium-transition metal composite oxide is measured, and a point at which the deformation amount of the particle sharply changes (an inflection point in the load-deformation amount profile) is specified as a fracture point. The fracture strength is calculated from the load and the particle diameter at that time based on the following formula. The particle fracture strength is an average value of fracture strength of ten particles of the lithium-transition metal composite oxide.

$$St = 2.8 P / π {d}^{2}$$

St: Fracture strength [MPa], P: Load [N], d: Particle diameter [mm]

An average particle diameter of the first positive electrode active material is preferably smaller than an average particle diameter of the second positive electrode active material. Further, the average particle diameter of the first positive electrode active material is more preferably greater than or equal to 3 μm and less than or equal to 6 μm or less, and the average particle diameter of the second positive electrode active material is more preferably greater than or equal to 10 μm and less than or equal to 13 μm or less. This can increase the filling density of the positive electrode active material in the positive electrode mixture layer, and thereby the battery capacity can be increased.

The first positive electrode active material is a lithium-transition metal composite oxide containing Ni and Mn, and a content rate of Ni is greater than or equal to 85 mol % and less than or equal to 94 mol % and a content rate of Co is less than or equal to 1 mol % relative to a total number of moles of metal elements excluding Li. Since the content rate of Ni is high, the battery capacity can be increased. In addition, since the content rate of Co is low, the cost can be reduced. The lithium-transition metal composite oxide preferably contains substantially no Co. The description “contain substantially no Co” means a case where Co is absolutely not contained and a case where Co is mixed as an impurity (a case where an amount of Co that cannot be precisely quantified is mixed). The mole fractions of the metal elements contained in the lithium-transition metal composite oxide can be measured by inductively coupled plasma (ICP) atomic emission spectrometry.

The first positive electrode active material is represented by, for example, the general formula LiₐNi_{b}Mn_{c}M1_{d}O₂, wherein 0.8≤a≤1.2, 0.85≤b≤0.94, 0.06≤c≤0.15, 0≤d≤0.01, b+c+d=1, and M1 represents at least one element selected from the group consisting of Co, Al, W, Nb, Mg, Ti, and Mo.

The second positive electrode active material is a lithium-transition metal composite oxide containing Ni and Co, and a content rate of Ni is greater than or equal to 85 mol % and less than or equal to 94 mol % and a content rate of Co is greater than or equal to 3 mol % relative to a total number of moles of metal elements excluding Li. Since the content rate of Ni is high, the battery capacity can be increased. An upper limit of the content rate of Co is, for example, 15 mol %.

The second positive electrode active material is represented by, for example, the general formula LiₑNi_{f}CO_{g}M2ₕO₂, wherein 0.8≤e≤1.2, 0.85≤f≤0.94, 0.03≤g≤0.15, 0≤h≤0.10, f+g+h=1, and M2 represents at least one element selected from the group consisting of Mn, Al, W, Nb, Mg, Ti, and Mo.

In the positive electrode mixture layer, a content of the first positive electrode active material is greater than or equal to 5 mass % and less than 50 mass % relative to a total mass of the first positive electrode active material and the second positive electrode active material. This can achieve both the low cost and improvement of the load characteristics. In the positive electrode mixture layer, the content of the first positive electrode active material is preferably greater than or equal to 10 mass % and less than 40 mass % relative to the total mass of the first positive electrode active material and the second positive electrode active material. The positive electrode mixture layer may include a positive electrode active material other than the first positive electrode active material and the second positive electrode mixture layer. For example, the positive electrode mixture layer may include a lithium-transition metal composite oxide having a content rate of Ni of greater than or equal to 0 mol % and less than 85 mol %. The total mass of the first positive electrode active material and the second positive electrode active material is preferably greater than or equal to 90 mass %, more preferably greater than or equal to 95 mass %, and further preferably greater than or equal to 99 mass % relative to a total mass of the positive electrode active material.

Next, an example of a method for manufacturing the lithium-transition metal composite oxide will be described.

The method for manufacturing the positive electrode active material includes: a first step of obtaining a composite oxide including metal elements such as Ni, Mn, and Co; and a second step of mixing and calcining the composite oxide obtained in the first step and other raw materials to obtain the lithium-transition metal composite oxide.

In the first step, the composite oxide including Ni and optional metal elements can be obtained by, while stirring a solution of metal salts including Ni, Mn, Co, and the like, a solution of an alkali such as sodium hydroxide is added dropwise to adjust a pH on the alkaline side (for example, greater than or equal to 8.5 and less than or equal to 12.5) to precipitate (coprecipitate) a composite hydroxide including Ni and the optional metal elements, and preliminarily calcining this composite hydroxide.

In the second step, the composite oxide obtained in the first step and a Li raw material are firstly mixed to obtain a mixture. A mass ratio between the composite oxide and the Li raw material is appropriately decided so that each element in the finally obtained Li-transition metal oxide becomes a desired proportion. Examples of the Li raw material include Li₂CO₃, LiOH, Li₂O₂, Li₂O, LiNO₃, LiNO₂, Li₂SO₄, LiOH·H₂O, LiH, and LiF.

The calcination of the mixture in the second step includes, for example: a first calcining step of calcining the mixture under an oxygen atmosphere from room temperature to a first set temperature, which is greater than or equal to 450° C. and less than or equal to 680° C.; and subsequently to the first calcining step, a second calcining step of calcining the mixture from the first set temperature to a second set temperature (highest reaching temperature), which is greater than or equal to 680° C. and less than or equal to 800° C. at a predetermined heating rate. A higher highest reaching temperature yields a smaller porosity of the lithium-transition metal composite oxide and higher particle fracture strength. A higher heating rate in the second calcining step yields a smaller porosity of the lithium-transition metal composite oxide and higher particle fracture strength. The particle fracture strength may be regulated by the composition of the lithium-transition metal composite oxide, in addition to the porosity. For example, a higher content rate of Co tends to yield higher particle fracture strength. The lithium-transition metal composite oxide obtained in the second step may be washed with water.

### [Negative Electrode]

The negative electrode 12 has, for example, a negative electrode current collector and a negative electrode mixture layer formed on a surface of the negative electrode current collector. The negative electrode mixture layer is preferably formed on both surfaces of the negative electrode current collector. For the negative electrode current collector, a foil of a metal stable within a potential range of the negative electrode, such as copper and a copper alloy, a film in which such a metal is disposed on a surface layer thereof, and the like may be used.

The negative electrode mixture layer includes, for example, a negative electrode active material and a binder. A content of the negative electrode active material in the negative electrode mixture layer is, for example, greater than or equal to 80 mass % and less than or equal to 99 mass % relative to a total mass of the negative electrode mixture layer. The negative electrode 12 can be produced by, for example, applying a negative electrode mixture slurry including the negative electrode active material, the binder, and the like on the surface of the negative electrode current collector, drying the coating film, and then compressing the coating film by using a roller or the like.

The negative electrode active material included in the negative electrode mixture layer is not particularly limited as long as it can reversibly occlude and release Li ions, and carbon materials such as graphite are typically used. The graphite may be any of natural graphite such as flake graphite, massive graphite, and amorphous graphite, and artificial graphite such as massive artificial graphite and graphitized mesophase carbon microbead. As the negative electrode active material, a metal that forms an alloy with Li, such as Si and Sn, a metal compound including Si, Sn, and the like, a lithium-titanium composite oxide, and the like may also be used. For example, a silicon oxide represented by SiOₓ (“x” represents greater than or equal to 0.5 and less than or equal to 1.6), a silicon-containing material in which Si fine particles are dispersed in a lithium silicate phase represented by Li_{2y}SiO_{(2+y)} (0<y<2), a silicon-containing material in which Si fine particles are dispersed in a carbon phase, or the like may be used in combination with the graphite.

Example of the binder included in the negative electrode mixture layer include styrene-butadiene rubber (SBR), nitrile-butadiene rubber (NBR), carboxymethylcellulose (CMC) or a salt thereof (which may be CMC-Na, CMC-K, CMC-NH₄, and the like, or a partially neutralized salt), polyacrylic acid (PAA) or a salt thereof (which may be PAA-Na, PAA-K, and the like, or a partially neutralized salt), and polyvinyl alcohol (PVA). These may be used singly, or may be used in combination of two or more thereof.

### [Separator]

For the separator 13, a porous sheet having an ion permeation property and an insulation property, or the like is used, for example. Specific examples of the porous sheet include a fine porous thin film, a woven fabric, and a nonwoven fabric. As a material for the separator, a polyolefin resin such as polyethylene and polypropylene, cellulose, or the like is preferable. The separator 13 may be a laminate having a cellulose fiber layer and a thermoplastic resin fiber layer such as an olefin resin. The separator 13 may be a multi-layer separator including a polyethylene layer and a polypropylene layer, or a separator in which a material such as an aramid resin and ceramic is applied on a surface of the separator 13 may be used.

### [Non-Aqueous Electrolyte]

The non-aqueous electrolyte is a liquid electrolyte (electrolyte liquid) including a non-aqueous solvent and an electrolyte salt dissolved in the non-aqueous solvent. For the non-aqueous solvent, esters, ethers, nitriles such as acetonitrile, amides such as dimethylformamide, a mixed solvent of two or more thereof, or the like may be used, for example. The non-aqueous solvents may contain a halogen-substituted derivative in which the hydrogen atoms of these solvents are at least partially replaced with a halogen atom such as fluorine.

Examples of the esters include: cyclic carbonates such as ethylene carbonate (EC), propylene carbonate (PC), and butylene carbonate; chain carbonates such as dimethyl carbonate (DMC), ethyl methyl carbonate (EMC), diethyl carbonate (DEC), methyl propyl carbonate, ethyl propyl carbonate, and methyl isopropyl carbonate; cyclic carboxylates such as γ-butyrolactone and γ-valerolactone; and chain carboxylates such as methyl acetate, ethyl acetate, propyl acetate, methyl propionate (MP), and ethyl propionate.

Examples of the ethers include: cyclic ethers such as 1,3-dioxolane, 4-methyl-1,3-dioxolane, tetrahydrofuran, 2-methyltetrahydrofuran, propylene oxide, 1,2-butylene oxide, 1,3-dioxane, 1,4-dioxane, 1,3,5-trioxane, furan, 2-methylfuran, 1,8-cineole, and a crown ether; and chain ethers such as 1,2-dimethoxyethane, diethyl ether, dipropyl ether, diisopropyl ether, dibutyl ether, dihexyl ether, ethyl vinyl ether, butyl vinyl ether, methyl phenyl ether, ethyl phenyl ether, butyl phenyl ether, pentyl phenyl ether, methoxytoluene, benzyl ethyl ether, diphenyl ether, dibenzyl ether, o-dimethoxybenzene, 1,2-diethoxyethane, 1,2-dibutoxyethane, diethylene glycol dimethyl ether, diethylene glycol diethyl ether, diethylene glycol dibutyl ether, 1,1-dimethoxymethane, 1,1-diethoxyethane, triethylene glycol dimethyl ether, and tetraethylene glycol dimethyl ether.

As the halogen-substituted derivative, fluorinated cyclic carbonates such as fluoroethylene carbonate (FEC), fluorinated chain carbonates, fluorinated chain carboxylates such as methyl fluoropropionate (FMP), and the like are preferably used.

The electrolyte salt is preferably a lithium salt. Examples of the lithium salt include LiBF₄, LiClO₄, LiPF₆, LiAsF₆, LiSbF₆, LiAlCl₄, LiSCN, LiCF₃SO₃, LiCF₃CO₂, Li(P(C₂O₄)F₄), LiPF₆₋ₓ(CₙF₂ₙ₊₁)ₓ (₁<x<₆, and “n” represents 1 or 2), LiB₁₀Cl₁₀, LiCl, LiBr, LiI, lithium chloroborane, a lithium lower aliphatic carboxylate, borate salts such as Li₂B₄O₇ and Li(B(C₂O₄)F₂), and imide salts such as LiN(SO₂CF₃)₂ and LiN(CₗF₂ₗ₊₁SO₂)(CₘF₂ₘ₊₁SO₂) {“l” and “m” represent integers of greater than or equal to 1}. These lithium salts may be used singly, or a plurality of types thereof may be mixed for use. Among them, LiPF₆ is preferably used from the viewpoints of ion conductivity, electrochemical stability, and the like. A concentration of the lithium salt is preferably greater than or equal to 0.8 mol and less than or equal to 1.8 mol per litter of the solvent.

### EXAMPLES

Hereinafter, the present disclosure will be further described with Examples, but the present disclosure is not limited to these Examples.

### Example 1

### [Production of First Positive Electrode Active Material]

A composite hydroxide obtained by a coprecipitation method and represented by [Ni_{0.88}Mn_{0.12}](OH)₂ was preliminarily calcined to obtain a composite oxide (Ni_{0.88}Mn_{0.12}O₂). Lithium hydroxide (LiOH) was mixed so that a mole ratio between Li and a total amount of Ni and Mn in the composite oxide was 1:1.02. This mixture was heated under an oxygen atmosphere from room temperature to 550° C. and then calcined from 550° C. to a highest reaching temperature at a predetermined heating rate. Thereafter, this calcined product was washed with water to obtain a first positive electrode active material. As a result of analysis by an ICP atomic emission spectrometer (trade name “iCAP6300”, manufactured by Thermo Fisher Scientific Inc.), the composition of the first positive electrode active material was Li_{0.98}Ni_{0.88}Mn_{0.12}O₂. An average particle diameter of the first positive electrode active material was 10 μm. A particle fracture strength of the first positive electrode active material was 84 MPa.

### [Production of Second Positive Electrode Active Material]

A composite hydroxide obtained by a coprecipitation method and represented by [Ni_{0.88}C_{00.07}Al_{0.05}](OH)₂ was preliminarily calcined to obtain a composite oxide (Ni_{0.88}C_{00.07}Al_{0.05}O₂). Lithium hydroxide (LiOH) was mixed so that a mole ratio between Li and a total amount of Ni, Co, and Al in the composite oxide was 1:1.02. This mixture was heated under an oxygen atmosphere from room temperature to 550° C. and then calcined from 550° C. to a highest reaching temperature at a predetermined heating rate. Note that the highest reaching temperature in the production of the second positive electrode active material was higher than the highest reaching temperature in the production of the first positive electrode active material. Thereafter, this calcined product was washed with water to obtain a lithium-transition metal composite oxide. As a result of analysis by an ICP atomic emission spectrometer (trade name “iCAP6300”, manufactured by Thermo Fisher Scientific Inc.), the composition of the second positive electrode active material was Li_{0.99}Ni_{0.88}Co_{0.07}Al_{0.05}O₂. An average particle diameter of the second positive electrode active material was 10 μm. A particle fracture strength of the second positive electrode active material was 125 MPa.

### [Production of Positive Electrode]

The first positive electrode active material and the second positive electrode active material were mixed at a mass ratio of 10:90 for use as a positive electrode active material. This positive electrode active material, carbon black, and polyvinylidene fluoride (PVDF) were mixed at a mass ratio of 100:1:1, and an appropriate amount of N-methyl-2-pyrrolidone (NMP) was added as a dispersion medium to prepare a positive electrode mixture slurry. Then, this positive electrode mixture slurry was applied on both surfaces of a positive electrode current collector composed of aluminum foil, the coating film was dried and rolled, and then cut to a predetermined electrode size to produce a positive electrode in which a positive electrode mixture layer is formed on both surfaces of the positive electrode current collector. An exposed portion where the surface of the positive electrode current collector was exposed was provided on a part of the positive electrode.

### [Production of Negative Electrode]

Mixing 100 parts by mass of artificial graphite, 1 part by mass of sodium carboxymethylcellulose (CMC-Na), 1.2 parts by mass of styrene-butadiene rubber (SBR), and water was performed to prepare a negative electrode mixture slurry. Then, this negative electrode mixture slurry was applied on both surfaces of a negative electrode current collector composed of copper foil, the coating film was dried and rolled, and then cut to a predetermined electrode size to produce a negative electrode in which a negative electrode mixture layer is formed on both surfaces of the negative electrode current collector. An exposed portion where the surface of the negative electrode current collector was exposed was provided on a part of the negative electrode.

### [Preparation of Non-Aqueous Electrolyte]

Ethylene carbonate (EC) and ethyl methyl carbonate (EMC) were mixed at a volume ratio of 3:7 to prepare a mixed solvent. Into this mixed solvent, lithium hexafluorophosphate (LiPF₆) was dissolved at a concentration of 1 mol/L to prepare a non-aqueous electrolyte.

### [Production of Secondary Battery]

A positive electrode lead made of aluminum was attached to the exposed portion of the positive electrode, and a negative electrode lead made of nickel was attached to the exposed portion of the negative electrode. The positive electrode and the negative electrode were spirally wound via a fine porous film separator made of polyethylene to produce a wound electrode assembly. This electrode assembly was housed in a bottomed cylindrical exterior housing can, the negative electrode lead was welded with a bottom inner face of the exterior housing can, and the positive electrode lead was welded with an internal terminal plate of a sealing assembly. Thereafter, the non-aqueous electrolyte was injected into the exterior housing can, and an end of an opening of the exterior housing can was caulked to the sealing assembly to produce a cylindrical secondary battery.

### [Calculation of Content Rate of Co]

Used as an index of the cost was a content rate of Co included in the positive electrode mixture layer. The content rate of Co was calculated as mol % relative to a total number of moles of metal elements in the first positive electrode active material and the second positive electrode active material excluding Li.

### [Evaluation of Direct Current Resistance (DCR)]

Under an environment temperature of 25° C., the secondary battery was charged at a constant current of 0.2 C until 4.2 V, and then charged at a constant voltage of 4.2 V until 0.01 C. Thereafter, the secondary battery was left to stand for 10 minutes, and then discharged at a constant current of 0.2 C until 2.5 V. Then, under environment temperature of 25° C., the secondary battery was charged at a constant current of 0.2 C until 4.2 V, and then charged at a constant voltage of 4.2 V until 0.01 C. Thereafter, the secondary battery was left to stand for 10 minutes, and then discharged at a constant current of 1.0 C for 10 seconds. A difference between the open circuit voltage (OCV) and the closed circuit voltage (CCV) after 10 seconds from the discharge was divided by the discharge current, and this value was specified as direct current resistance (DCR).

### Example 2

A secondary battery was produced and evaluated in the same manner as in Example 1 except that, in the production of the second positive electrode active material, a composite hydroxide represented by [Ni_{0.88}Co_{0.07}Mn_{0.05}](OH)₂ was used to produce a second positive electrode active material having a composition represented by Li_{0.99}Ni_{0.88}Co_{0.07}Mn_{0.05}O₂. This second positive electrode active material had an average particle diameter of 10 μm, which was same as in Example 1.

### Example 3

A secondary battery was produced and evaluated in the same manner as in Example 1 except that, in the production of the second positive electrode active material, a composite hydroxide represented by [Ni_{0.88}Co_{0.07}Al_{0.025}Mn_{0.025}](OH)₂ was used to produce a second positive electrode active material having a composition represented by Li_{0.99}Ni_{0.88}Co_{0.07}Al_{0.025}Mn_{0.025}O₂. This second positive electrode active material had an average particle diameter of 10 μm, which was same as in Example 1.

### Example 4

A secondary battery was produced and evaluated in the same manner as in Example 1 except that, in the production of the positive electrode, a mass ratio between the first positive electrode active material and the second positive electrode active material was changed to 20:80.

### Example 5

A secondary battery was produced and evaluated in the same manner as in Example 1 except that, in the production of the positive electrode, a mass ratio between the first positive electrode active material and the second positive electrode active material was changed to 40:60.

### Comparative Example 1

A secondary battery was produced and evaluated in the same manner as in Example 1 except that, in the production of the positive electrode, the first positive electrode active material and the second positive electrode active material were not mixed, and only the second positive electrode active material was used as the positive electrode active material.

### Comparative Example 2

A secondary battery was produced and evaluated in the same manner as in Example 1 except that, in the production of the positive electrode, a mass ratio between the first positive electrode active material and the second positive electrode active material was changed to 50:50.

### Comparative Example 3

A secondary battery was produced and evaluated in the same manner as in Example 1 except that, in the production of the positive electrode, a mass ratio between the first positive electrode active material and the second positive electrode active material was changed to 80:20.

### Comparative Example 4

A secondary battery was produced and evaluated in the same manner as in Example 1 except that, in the production of the positive electrode, the first positive electrode active material and the second positive electrode active material were not mixed, and only the first positive electrode active material was used as the positive electrode active material.

### Comparative Example 5

A secondary battery was produced and evaluated in the same manner as in Example 1 except that: in the production of the first positive electrode active material, the highest reaching temperature was set to be higher than that in Example 1; and in the production of the positive electrode, the first positive electrode active material and the second positive electrode active material were not mixed, and only the first positive electrode active material was used as the positive electrode active material. This first positive electrode active material had a particle fracture strength of 115 MPa. This first positive electrode active material had an average particle diameter of 10 μm, which was same as in Example 1.

### Comparative Example 6

A secondary battery was produced and evaluated in the same manner as in Example 1 except that: in the production of the first positive electrode active material, the heating rate from 550° C. to the highest reaching temperature was set to be higher than that in Example 1; and in the production of the positive electrode, the first positive electrode active material and the second positive electrode active material were not mixed, and only the first positive electrode active material was used as the positive electrode active material. This first positive electrode active material had a particle fracture strength of 121 MPa. This first positive electrode active material had an average particle diameter of 10 μm, which was same as in Example 1.

### Comparative Example 7

A secondary battery was produced and evaluated in the same manner as in Example 1 except that: in the production of the first positive electrode active material, the highest reaching temperature was set to be lower than that in Example 1; and in the production of the positive electrode, the first positive electrode active material and the second positive electrode active material were not mixed, and only the first positive electrode active material was used as the positive electrode active material. This first positive electrode active material had a particle fracture strength of 82 MPa. This first positive electrode active material had an average particle diameter of 10 μm, which was same as in Example 1.

Table 1 shows the evaluation results of the secondary batteries of Examples and Comparative Examples. In Table 1, the results of DCR in Examples 1 to 5 and Comparative Examples 2 to 7 are shown as a value relative to DCR of the battery of Comparative Example 1 being 100. Table 1 also shows the compositions and particle fracture strength of the first positive electrode active material and the second positive electrode active material, and the mixing ratio between the first positive electrode active material and the second positive electrode active material.

TABLE 1

| | First positive electrode | | Second positive electrode | | | | |
|---|---|---|---|---|---|---|---|
| | active material | | active material | | | | |
| | | Particle | | Particle | | Co | |
| | | strength | | strength | Mixing ratio | content | Reaction |
| | Composition | [MPa] | Composition | [MPa] | (first:second) | rate | resistance |
| Example 1 | Li_{0.98}Ni_{0.88}Mn_{0.12}O₂ | 84 | Li_{0.99}Ni_{0.88}Co_{0.07}Al_{0.05}O₂ | 125 | 10:90 | 6.3 | 110 |
| Example 2 | Li_{0.98}Ni_{0.88}Mn_{0.12}O₂ | 84 | Li_{0.99}Ni_{0.88}Co_{0.07}Mn_{0.05}O₂ | 123 | 10:90 | 6.3 | 105 |
| Example 3 | Li_{0.98}Ni_{0.88}Mn_{0.12}O₂ | 84 | Li_{0.99}Ni_{0.88}Co_{0.07}Al_{0.025}Mn_{0.025}O₂ | 145 | 10:90 | 6.3 | 105 |
| Example 4 | Li_{0.98}Ni_{0.88}Mn_{0.12}O₂ | 84 | Li_{0.99}Ni_{0.88}Co_{0.07}Al_{0.05}O₂ | 125 | 20:80 | 5.6 | 110 |
| Example 5 | Li_{0.98}Ni_{0.88}Mn_{0.12}O₂ | 84 | Li_{0.99}Ni_{0.88}Co_{0.07}Al_{0.05}O₂ | 125 | 40:60 | 4.2 | 115 |
| Comparative | — | — | Li_{0.99}Ni_{0.88}Co_{0.07}Al_{0.05}O₂ | 125 | 0:100 | 7.0 | 100 |
| Example 1 | | | | | | | |
| Comparative | Li_{0.98}Ni_{0.88}Mn_{0.12}O₂ | 84 | Li_{0.99}Ni_{0.88}Co_{0.07}Al_{0.05}O₂ | 125 | 50:50 | 3.5 | 150 |
| Example 2 | | | | | | | |
| Comparative | Li_{0.98}Ni_{0.88}Mn_{0.12}O₂ | 84 | Li_{0.99}Ni_{0.88}Co_{0.07}Al_{0.05}O₂ | 125 | 80:20 | 1.4 | 240 |
| Example 3 | | | | | | | |
| Comparative | Li_{0.98}Ni_{0.88}Mn_{0.12}O₂ | 84 | — | — | 100:0 | 0 | 260 |
| Example 4 | | | | | | | |
| Comparative | Li_{0.98}Ni_{0.88}Mn_{0.12}O₂ | 115 | — | — | 100:0 | 0 | 235 |
| Example 5 | | | | | | | |
| Comparative | Li_{0.98}Ni_{0.88}Mn_{0.12}O₂ | 121 | — | — | 100:0 | 0 | 160 |
| Example 6 | | | | | | | |
| Comparative | Li_{0.98}Ni_{0.88}Mn_{0.12}O₂ | 82 | — | — | 100:0 | 0 | 490 |
| Example 7 | | | | | | | |

The secondary batteries of Comparative Examples 2 to 7 exhibited considerably increased DCR with reduction in the content rate of Co compared with the secondary battery of Comparative Example 1. The secondary batteries of Examples, however, remarkably inhibited the increase in DCR with reduction in the Co content rate compared with the secondary batteries of Comparative Examples. Therefore, both the low cost and the improvement of the load characteristics can be achieved by mixing, at a predetermined mass ratio: the first positive electrode active material having a particle fracture strength of less than or equal to 90 MPa and containing Ni and Mn; and the second positive electrode active material having a particle fracture strength of greater than or equal to 110 MPa and containing Ni and Co.

### REFERENCE SIGNS LIST

10 Non-aqueous electrolyte secondary battery, 11 Positive electrode, 12 Negative electrode, 13 Separator, 14 Electrode assembly, 16 Exterior housing can, 17 Sealing assembly, 18, 19 Insulating plate, 20 Positive electrode lead, 21 Negative electrode lead, 22 Grooved portion, 23 Internal terminal plate, 24 Lower vent member, 25 Insulating member, 26 Upper vent member, 27 Cap, 28 Gasket

1. A non-aqueous electrolyte secondary battery, comprising:
a positive electrode;
a negative electrode;
a separator separating the positive electrode and the negative electrode from each other; and
a non-aqueous electrolyte, wherein
the positive electrode has a positive electrode current collector and a positive electrode mixture layer formed on a surface of the positive electrode current collector,
the positive electrode mixture layer includes a first positive electrode active material having a particle fracture strength of less than or equal to 90 MPa and a second positive electrode active material having a particle fracture strength of greater than or equal to 110 MPa,
the first positive electrode active material is a lithium-transition metal composite oxide containing Ni and Mn, and a content rate of Ni is greater than or equal to 85 mol % and less than or equal to 94 mol % and a content rate of Co is less than or equal to 1 mol % relative to a total number of moles of metal elements excluding Li,
the second positive electrode active material is a lithium-transition metal composite oxide containing Ni and Co, and a content rate of Ni is greater than or equal to 85 mol % and less than or equal to 94 mol % and a content rate of Co is greater than or equal to 3 mol % relative to a total number of moles of metal elements excluding Li, and
in the positive electrode mixture layer, a content of the first positive electrode active material is greater than or equal to 5 mass % and less than 50 mass % relative to a total mass of the first positive electrode active material and the second positive electrode active material.

2. The non-aqueous electrolyte secondary battery according to claim 1, wherein, in the positive electrode mixture layer, the content of the first positive electrode active material is greater than or equal to 10 mass % and less than 40 mass % relative to the total mass of the first positive electrode active material and the second positive electrode active material.

3. The non-aqueous electrolyte secondary battery according to claim 1, wherein
the first positive electrode active material is represented by the general formula LiₐNi_{b}Mn_{c}M1_{d}O₂, wherein 0.8≤a≤1.2, 0.85≤b≤0.94, 0.06≤c≤0.15, 0≤d≤0.01, b+c+d=1, and M1 represents at least one element selected from the group consisting of Co, Al, W, Nb, Mg, Ti, and Mo, and
the second positive electrode active material is represented by the general formula LiₑNi_{f}CO_{g}M2ₕO₂, wherein 0.8≤e≤1.2, 0.85≤f≤0.94, 0.03≤g≤0.15, 0≤h≤0.10, f+g+h=1, and M2 represents at least one element selected from the group consisting of Mn, Al, W, Nb, Mg, Ti, and Mo.
